(19) United States
(12) Patent Application Publication
(10) Pub. No.: US 2014/0367418 A1
(43) Pub. Date: Dec. 18, 2014

(54) Portable Beverage Dispensing System

(71) Applicants: Mark McNitt, Buffalo, MN (US); Anh Nguyen, Brooklyn Park, MN (US)

(72) Inventors: Mark McNitt, Buffalo, MN (US); Anh Nguyen, Brooklyn Park, MN (US)

(21) Appl. No.: 13/918,965

(22) Filed: Jun. 16, 2013

(51) Int. Cl. B67D 1/08

(52) U.S. Cl. CPC B67D 1/0891
USPC 222/183

(57) ABSTRACT

The portable beverage dispensing system disclosed is a portable cooler for dispensing bulk beverages, such as beer in various sized kegs, for example, comprising: a lower tub component that defines an open interior region for removably receiving the keg(s); a hollow upper component that removably attaches to the lower tub component and surrounds the upper portion of the keg(s); and a table top that removably attaches to the hollow upper component and which may furthermore have aperture(s) that allow standard beverage dispensing components to pass through and attach to the table top for dispensing of beverages. The portable beverage dispensing system may also comprise: a wheel attachment apparatus, connected to the lower tub in a fixed or removable manner; and a handle apparatus, connected to the table top in a fixed or removable manner; both of which allow portability of the portable beverage dispensing system.

### PRIORITY CLAIM

This application discloses and claims subject matter that is disclosed in applicant's copending U.S. provisional application Ser. No. 61/661,795 that was filed Jun. 19, 2012.

### BACKGROUND OF THE INVENTION

While there are a number of portable keg coolers, containers, and related vessels, it would be desirable to provide a portable beverage dispensing system which could be quickly set up and collapsed, and easily transported. It would also be desirable to provide a portable beverage dispensing system that presents the beverages at a convenient table top surface of the dispensing system. It would furthermore be desirable to provide a portable beverage dispensing system which has wheels and handles for portability and yet which are removable for a more aesthetic presentation of the portable beverage dispensing system once it is emplaced.

### BRIEF SUMMARY OF THE INVENTION

In accordance with the present invention, a portable beverage dispensing system for carrying and storing one or more beverage kegs is disclosed. The portable beverage dispensing system is comprised of: a lower tub component that defines an open interior region for removably receiving one or more beverage kegs; a hollow upper component that removably attaches to the lower tub and surrounds the upper portion of the one or more beverage kegs; and a table top that removably attaches to the hollow upper tub and which may furthermore have one or more apertures that allow standard beverage dispensing components to pass through and attach to the table top for dispensing of beverages. The portable beverage dispensing system may also comprise: a wheel attachment apparatus, connected to the lower tub in a fixed or removable manner; and a handle apparatus, connected to the table top in a fixed or removable manner; both of which allow portability of the beverage dispensing system.

In one exemplary embodiment, the lower tub component of the portable beverage dispensing system may be configured as a hollow cylinder with a fixed bottom portion on which one or more beverage kegs would rest; and the hollow upper component may be configured as a hollow cylinder. In such an embodiment, the cylindrical lower tub component and the cylindrical hollow upper component may have diameters that are similar in size. In other such embodiments, either the cylindrical lower tub component or the cylindrical hollow upper component may be configured with a diameter that is larger in size than that of the other, so as to allow the larger of the two components to be nested over the smaller of the two components to form an alternate storage configuration for the portable beverage dispensing system.

In another exemplary embodiment, the lower tub component of the portable beverage dispensing system may be configured as a hollow tapered-cylinder with a fixed bottom portion on which one or more beverage kegs would rest and the hollow upper component may be configured as a hollow tapered-cylinder. In such embodiments, the tapered-cylindrical lower tub component and the tapered-cylindrical hollow upper component may be configured such that the smaller diameters of each component and the larger diameters of each component are similar in size, respectively. In other such embodiments, either the tapered-cylindrical lower tub component or the tapered-cylindrical hollow upper component may be configured so that its smaller and larger diameters are larger in size than that of the other, so as to allow the larger of the two components to be nested over the smaller of the two components to form an alternate storage configuration for the portable beverage dispensing system.

In at least one exemplary embodiment, the lower tub component is configured as a hollow tapered-cylinder with a fixed bottom portion on which one or more beverage kegs would rest and where the bottom of the lower tub component is larger in diameter than its top; and the hollow upper component is configured with a hollow tapered-cylindrical shape, where the bottom of the hollow upper component is smaller in diameter than its top. In such an embodiment, the tapered-cylindrical hollow upper component may be configured such that its smaller and larger diameters are larger in size than those of the tapered-cylindrical lower tub component, respectively, so as to allow the tapered-cylindrical hollow upper component to be flipped upside down and nested over the tapered-cylindrical lower tub component, forming an alternate storage configuration for the portable beverage dispensing system.

### BRIEF DESCRIPTION OF THE DRAWING VIEWS

The invention is further described in connection with the accompanying drawings.

FIG. 1 is an isometric depiction of the disclosed portable beverage dispensing system.

FIG. 2 is an exploded isometric depiction of the disclosed portable beverage dispensing system.

FIG. 3 is an isometric depiction of the disclosed portable beverage dispensing system in an alternate storage configuration.

FIG. 4 is an exploded isometric depiction of the disclosed portable beverage dispensing system in an alternate storage configuration.

### DETAILED DESCRIPTION

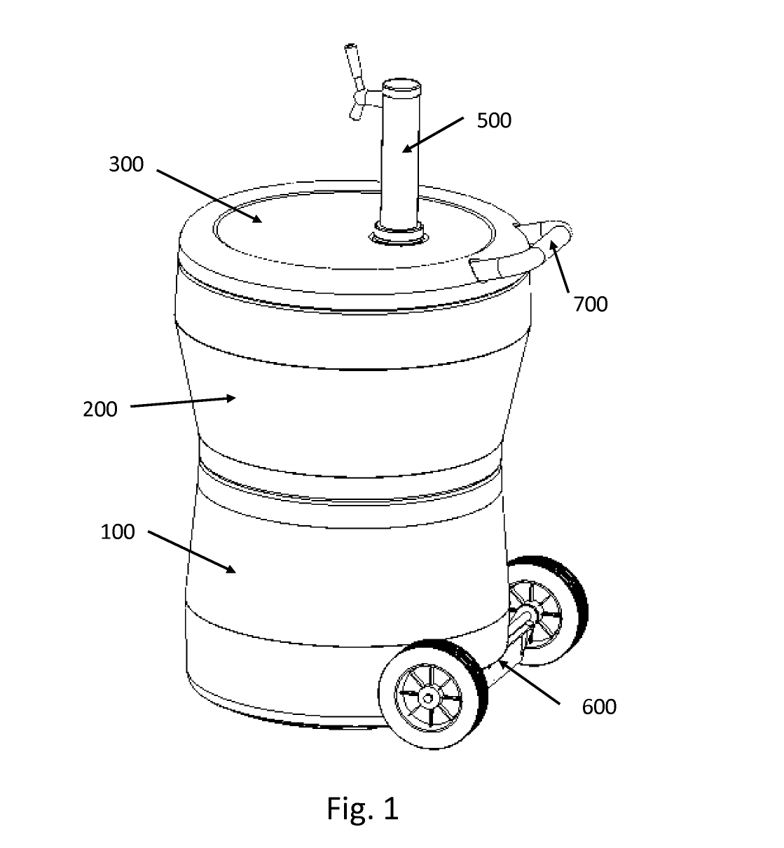

As depicted in FIG. 1, a portable beverage dispensing system for carrying and storing one or more beverage kegs is disclosed, which is comprised of: a lower tub component 100 that defines an open interior region for removably receiving one or more beverage kegs 400; a hollow upper component 200 that removably attaches to the lower tub 100 and surrounds the upper portion of the one or more beverage kegs 400; and a table top 300 that removably attaches to the hollow upper tub 200 and which may furthermore have aperture(s) that allow standard beverage dispensing components 500 to pass through and attach to the table top for dispensing of beverages. The portable beverage dispensing system may also comprise: a wheel attachment apparatus 600, connected to the lower tub 100 in a fixed or removable manner; and a handle apparatus 700, connected to the table top 300 in a fixed or removable manner; both of which allow portability of the beverage dispensing system.

In one exemplary embodiment, the lower tub component 100 of the portable beverage dispensing system may configured as a hollow cylinder with a fixed bottom portion on which one or more beverage kegs 400 would rest; and the hollow upper component 200 may be configured as a hollow cylinder. In such an embodiment, the cylindrical lower tub component 100 and cylindrical hollow upper component 200 may have diameters that are similar in size. In other such embodiments, either the cylindrical lower tub component 100 or the cylindrical hollow upper component 200 may be configured with a diameter that is larger in size than that of the other, so as to allow the larger of the two components to be nested over the smaller of the two components to form an alternate storage configuration for the portable beverage dispensing system.

In another exemplary embodiment, the lower tub component 100 may be configured as a hollow tapered-cylinder with a fixed bottom portion on which one or more beverage kegs 400 would rest; and the hollow upper component 200 may be configured as a hollow tapered-cylinder. In such embodiments, the tapered-cylindrical lower tub component 100 and the tapered-cylindrical hollow upper component 200 may be configured such that the smaller diameters of each component and the larger diameters of each component are similar in size, respectively. In other such embodiments, either the tapered-cylindrical lower tub component 100 or the tapered-cylindrical hollow upper component 200 may be configured so that its smaller and larger diameters are larger in size than those of the other, respectively, so as to allow the larger of the two components to be nested over the smaller of the two components, forming an alternate storage configuration for the portable beverage dispensing system.

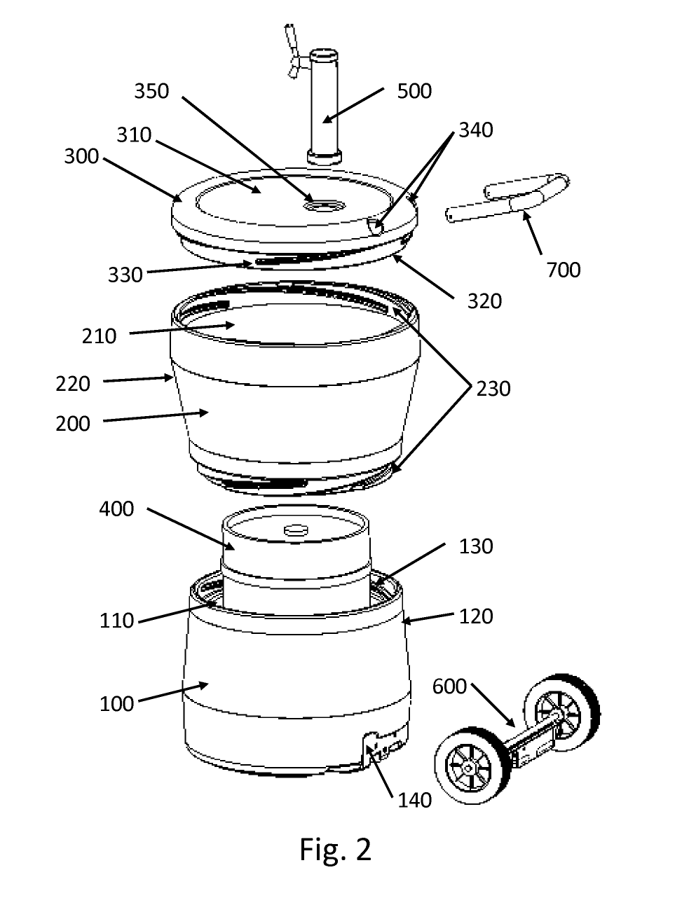

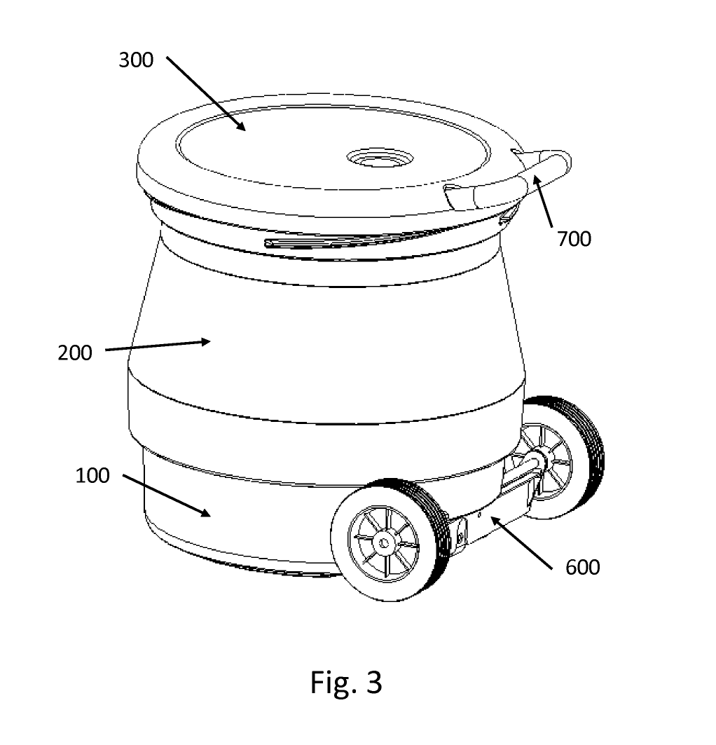

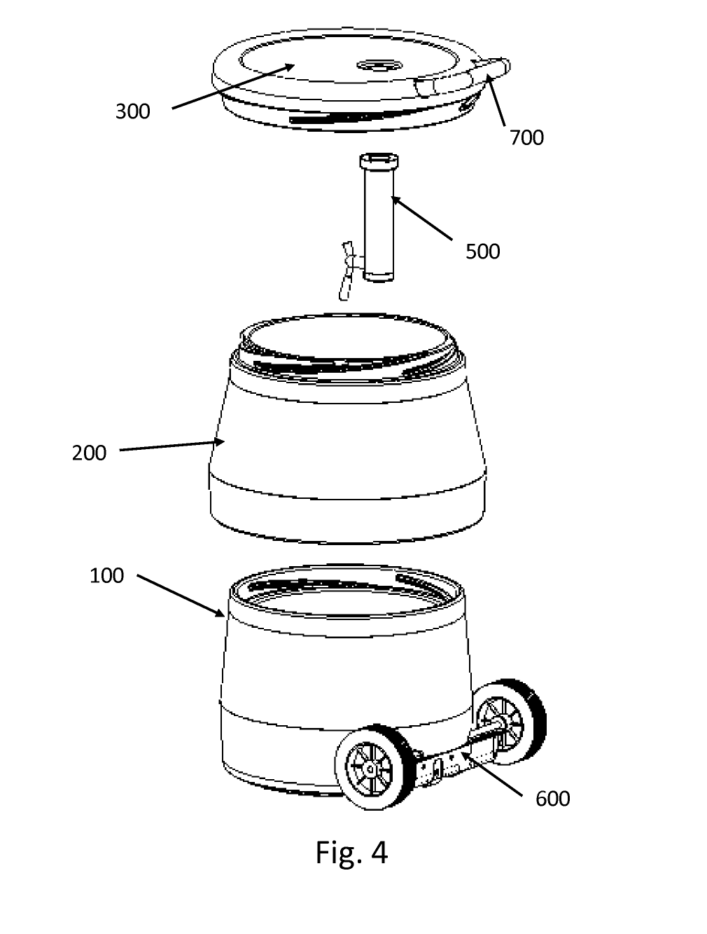

In at least one exemplary embodiment, the lower tub component 100 is configured as a hollow tapered-cylinder with a fixed bottom portion on which one or more beverage kegs 400 would rest and where the bottom of the lower tub component 100 is larger in diameter than its top, as depicted in FIG. 1 and FIG. 2. In such an embodiment, the hollow upper component 200 may be configured with a hollow tapered-cylindrical shape, where the bottom of the hollow upper component 200 is smaller in diameter than its top, as also depicted in FIG. 1 and FIG. 2. In such an embodiment, the tapered-cylindrical hollow upper component 200 may be configured such that its smaller and larger diameters are larger in size than those of the tapered-cylindrical lower tub component 100, respectively, so as to allow the tapered-cylindrical hollow upper component 200 to be flipped upside down and nested over the tapered-cylindrical lower tub component 100, forming an alternate storage configuration for the portable beverage dispensing system, as depicted in FIG. 3 and FIG. 4.

In some exemplary embodiments, the lower tub component 100 may be made from a single-walled material. In other exemplary embodiments, the lower tub component 100 may be made to have multiple walls, thereby forming a hollow cross-section. In such embodiments, the inner wall surfaces 110 of lower tub component 100 may be configured to have a different shape than the outer wall surfaces 120 of the lower tub component 100.

In at least one exemplary embodiment, the lower tub component 100 may be made as a single plastic part through a rotomolding process, thereby forming such a hollow cross-section.

In other such embodiments, such a hollow cross-section of the lower tub component 100 may be formed of other materials, and may further be formed from other manufacturing methods.

In some exemplary embodiments of the present invention, the lower tub component 100 may have protruding or recessed features 130, as shown in FIG. 2, configured to connect or engage with corresponding protruding or recessed features 230 on the hollow upper component 200, thereby forming a structural connection when the two components are assembled together. In at least one exemplary embodiment, the protruding or recessed features 130 on the lower tub component 100 may be configured as thread-like features that would connect or engage with corresponding thread-like protruding or recessed features 230 on the hollow upper component.

Other embodiments may use latches, screws, or other common fastening methods to create a structural connection between the lower tub component 100 and the hollow upper component 200, as could be readily determined by someone with ordinary skills in the art.

In some embodiments of the present invention, the lower tub component 100 may include an integral wheel attachment apparatus 600 or may include attachment features 140, designed to accommodate wheel attachment apparatus 600. Such features could include apertures, recesses, protrusions, latches, fasteners, or other such features in such a way as to allow the wheel attachment apparatus 600 to attach to the lower tub component 100 in a fixed or removable manner, as could be readily determined by someone with ordinary skills in the art.

In some exemplary embodiments of the present invention, the lower tub component 100 may also include a separate aperture for use as a drain feature.

In some exemplary embodiments, the hollow upper component 200 may be made from a single-walled material. In other exemplary embodiments, the hollow upper component 200 may be made to have multiple walls, thereby forming a hollow cross-section. In such embodiments, the inner wall surfaces 210 of hollow upper component 200 may be configured to have a different shape than the outer wall surfaces 220 of the hollow upper component 200.

In at least one exemplary embodiment, the hollow upper component 200 may be made as a single plastic part through a rotomolding process, thereby forming such a hollow cross-section.

In other such embodiments, such a hollow cross-section of the hollow upper component 200 may be formed of other materials, and may further be formed from other manufacturing methods.

In some exemplary embodiments of the present invention, the hollow upper component 200 may have protruding or recessed features 230, as shown in FIG. 2, configured to connect or engage with corresponding protruding or recessed features 130 on the lower component 100 and protruding or recessed features 330 on the table top 300, and thereby forming structural connections when the components are assembled together. In at least one exemplary embodiment, the protruding or recessed features 230 on the hollow upper component 200 may be configured as thread-like features that would connect or engage with corresponding thread-like protruding or recessed features 130 on the lower tub component 100 and corresponding thread-like protruding or recessed features 330 on the table top 300.

Other embodiments may use latches, screws, or other common fastening methods to create structural connections between the hollow upper component 200, the lower tub component 100, and the table top 300, as could be readily determined by someone with ordinary skills in the art.

In some exemplary embodiments, the table top 300 may be made from a single-walled material. In other exemplary embodiments, the table top 300 may be made to have multiple walls, thereby forming a hollow cross-section. In such embodiments, the topside surfaces 310 of the table top 300 may be configured to have a different shape than the underside surfaces 320 of the table top 300.

In at least one exemplary embodiment, the table top 300 may be made as a single plastic part through a rotomolding process, thereby forming such a hollow cross-section.

In other such embodiments, such a hollow cross-section of the table top 300 may be formed of other materials, and may further be formed from other manufacturing methods.

In some exemplary embodiments of the present invention, the table top 300 may have protruding or recessed features 330, as shown in FIG. 2, configured to connect or engage with corresponding protruding or recessed features 230 on the hollow upper component 200, thereby forming a structural connection when the two components are assembled together. In at least one exemplary embodiment, the protruding or recessed features 330 on the table top 300 may be configured as thread-like features that would connect or engage with corresponding thread-like protruding or recessed features 230 on the hollow upper component 200.

Other embodiments may use latches, screws, or other common fastening methods to create a structural connection between the table top 300 and the hollow upper component 200, as could be readily determined by someone with ordinary skills in the art.

In some embodiments of the present invention, the table top 300 may include an integral handle apparatus 700 or attachment features 340, designed to accommodate handle apparatus 700. Such features could include apertures, recesses, protrusions, or other such features in such a way as to allow the handle apparatus 700 to attach to the table top 300 in a fixed or removable manner, as could be readily determined by someone with ordinary skills in the art.

In even further embodiments of the present invention, the table top 300 may include one or more apertures 350 configured to accommodate standard beverage dispensing components 500, where the number and shape of such apertures 350 could be readily determined by someone with ordinary skills in the art. Such apertures 350 may further be configured to allow the beverage dispensing components 500 to attach to the top of the table top 300, as depicted in FIG. 2, and to the underside of the table top 300 for storage, as depicted in FIG. 4.

Unless otherwise specified in this description, the components of the present invention may be made from plastics, polymers, metals, or any other rigid material suitable for use within a beverage cooler system, provided such materials possess properties suitable for the loads and conditions typically present in such an application. Additionally, unless otherwise specified in the description, when components are attached to each other, they may be attached using various welding techniques, with screws, nails, glue, or by any suitable technique for attaching metal or non-metal components to other metal or non-metal components.

The above is a detailed description of particular embodiments of the invention. It is recognized that departures from the disclosed embodiments may be within the scope of this invention and that obvious modifications will occur to a person skilled in the art. It is the intent of the applicant that the invention include alternative embodiments known in the art that perform the same functions as those disclosed. This specification should not be construed to unduly narrow the full scope of protection to which the invention is entitled.

I claim:

1. A portable beverage dispensing system comprising:
a lower tub component that defines an open interior region for removably receiving one or more beverage kegs;
a hollow upper component that removably attaches to the lower tub and surrounds the upper portion of the one or more beverage kegs;
a table top that removably attaches to the hollow upper tub.

2. The portable beverage dispensing system of claim 1, wherein the lower tub component is configured as a hollow cylinder with a fixed bottom portion on which one or more beverage kegs would rest and the hollow upper component is configured as a hollow cylinder.

3. The portable beverage dispensing system of claim 2, wherein the cylindrical lower tub component and the cylindrical hollow upper component have diameters that are similar in size.

4. The portable beverage dispensing system of claim 2, wherein the cylindrical lower tub component is configured with a diameter that is larger in size than that of the or the cylindrical hollow upper component, so as to allow the cylindrical hollow upper component be nested inside of the cylindrical lower tub component to form an alternate storage configuration for the portable beverage dispensing system.

5. The portable beverage dispensing system of claim 2, wherein the cylindrical hollow upper component is configured with a diameter that is larger in size than that of the cylindrical lower tub component, so as to allow the cylindrical hollow upper component to be nested over the cylindrical lower tub component to form an alternate storage configuration for the portable beverage dispensing system.

6. The portable beverage dispensing system of claim 2, wherein the lower tub component of the portable beverage dispensing system is configured as a hollow tapered-cylinder with a fixed bottom portion on which one or more beverage kegs would rest and the hollow upper component is configured as a hollow tapered-cylinder.

7. The portable beverage dispensing system of claim 6, wherein the tapered-cylindrical lower tub component and the tapered-cylindrical hollow upper component are configured such that the smaller diameters of each component and the larger diameters of each component are similar in size, respectively.

8. The portable beverage dispensing system of claim 6, wherein the tapered-cylindrical hollow upper tub component is configured so that its smaller and larger diameters are smaller in size than those of the tapered-cylindrical lower component, so as to allow the tapered-cylindrical hollow upper component to be nested inside the tapered-cylindrical lower tub component to form an alternate storage configuration for the portable beverage dispensing system.

9. The portable beverage dispensing system of claim 6, wherein the tapered-cylindrical hollow upper component is configured so that its smaller and larger diameters are larger in size than that of the tapered-cylindrical lower tub component, so as to allow the tapered-cylindrical hollow upper component to be nested over the tapered-cylindrical lower tub component to form an alternate storage configuration for the portable beverage dispensing system.

10. The portable beverage dispensing system of claim 1 wherein the hollow upper component has protruding or recessed features configured to connect or engage with corresponding protruding or recessed features on the lower component and protruding or recessed features on the table top, thereby forming structural connections when the components are assembled together.

11. The portable beverage dispensing system of claim 10 wherein the protruding or recessed features on the hollow upper component are configured as thread-like features that would connect or engage with corresponding thread-like protruding or recessed features on the lower tub component and corresponding thread-like protruding or recessed features on the table top.

12. The portable beverage dispensing system of claim 1 wherein the table top includes one or more apertures configured to accommodate standard beverage dispensing components.

13. The portable beverage dispensing system of claim 12 wherein the one or more apertures in the table top are configured to allow the beverage dispensing components to attach to the top of the table top for normal use and to the underside of the table top for storage purposes.

14. The portable beverage dispensing system of claim 1 wherein a wheel attachment apparatus is connected to the lower tub in a fixed or removable manner.

15. The portable beverage dispensing system of claim 1 wherein a handle apparatus is connected to the table top in a fixed or removable manner.
